(19) United States
(12) Patent Application Publication
(10) Pub. No.: US 2012/0111605 A1
(43) Pub. Date: May 10, 2012

(54) CURABLE SOL-GEL COMPOSITION

(75) Inventors: Spiros TZAVALAS, Lengnau (CH); Bandeep SINGH, Wytheville, VA (US); Xavier KORNMANN, Lauchringen (DE)

(73) Assignee: ABB RESEARCH LTD., Zurich (CH)

(21) Appl. No.: 13/289,465

(22) Filed: Nov. 4, 2011

Related U.S. Application Data
(63) Continuation of application No. PCT/EP2009/055398, filed on May 5, 2009.

(51) Int. Cl. H01B 17/50; C08K 5/053; C08K 5/05; B05D 5/12; C09D 163/00

(52) U.S. Cl. 174/137 A; 427/58; 523/466; 523/456

(57) ABSTRACT

Curable sol-gel composition useful for modifying the surface of a conventional electrical insulation system and providing said surface with an improved tracking and erosion resistance, wherein said sol-gel composition includes: (a) cyclo-aliphatic epoxy resin compound containing at least two 1,2-epoxy groups per molecule [component (a)]; (b) a glycidoxypropane-tri(C₁₋₄)alkoxysilane [component (b)]; (c) a gamma-aminopropyl-tri(C₁₋₄)alkoxysilane [component (c)]; (d) a mineral filler material [component (d)]; and (e) a hydrophobic compound [component (e)] or a mixture of such hydrophobic compounds being selected from fluorinated or chlorinated hydrocarbons or organopolysiloxanes.

### RELATED APPLICATION

This application claims priority as a continuation application under 35 U.S.C. §120 to PCT/EP2009/055398 filed as an International Application on May 5, 2009 designating the U.S., the entire content of which is hereby incorporated by reference in its entirety.

### FIELD

Disclosed is a curable sol-gel composition useful for modifying the outer surface of a conventional electrical insulation system and providing said surface with an improved tracking and erosion resistance. This can be achieved by applying the curable sol-gel composition to the outer surface of the electrical insulation system and curing the applied sol-gel composition, whereby a thin cured coating composition is formed which provides said electrical insulation system with an improved tracking and erosion resistance. Also disclosed is a surface modified electrical insulation system, the outer surface of said electrical insulation system being coated with a thin coating composition made from a selected cured sol-gel composition as described herein.

### BACKGROUND INFORMATION

Electrical insulations can be exposed to surface discharges in service. The temperature of such surface discharges can be higher than 1000° C. (>1000° C.). In the case of electrical insulation systems based on synthetic polymers filled with a filler composition, these high discharge temperatures lead to erosion and carbonization (also called tracking) of the surface of the insulation material since the degradation temperature of polymeric insulation material can be much lower than 1000° C., for example, lower than 400° C. Epoxy resin compositions can start to degrade at temperatures around 250° C.

In U.S. Pat. No. 6,541,118, an electrical insulator with a molding made of a ceramic and a hydrophobic coating applied to the ceramic surface is disclosed. The hydrophobic coating comprises a plasma polymer having been applied directly to the ceramic. Ceramic materials are very stable having a high dimensional stability and good resistance to heat. It is therefore possible to coat the ceramic surface with a plasma polymer coating by applying said plasma coating directly to the ceramic surface.

Electrical indoor insulations can be based on synthetic polymers such as epoxy resin compositions, polyester compositions or polyurethane compositions. Electrical indoor insulations based on epoxy resin compositions can be made from aromatic epoxy resin compounds. However, cured epoxy resin compositions comprising aromatic moieties undergo degradation due to UV-radiation and their outdoor use therefore is limited. Epoxy resin compositions based on cycloaliphatic epoxy resin compounds, therefore, can be used for electrical outdoor insulations.

The resistance of electrical insulators to electrical surface discharges without degradation can be measured with the (International Electrotechnical Commission) IEC 60587 inclined plane tracking standard test. Indoor epoxy (IEP) compositions based on aromatic epoxy resin compounds and polyurethane (PU) compositions repeatedly fail the 3.5 kV level of the inclined tracking and erosion test (class 1A3.5 according to standard IEC 60587). Therefore, it can be beneficial to increase the time during which such polymeric insulation can withstand exposure to the high temperatures of surface discharges without degradation.

### SUMMARY

According to an exemplary aspect, a curable sol-gel composition suitable for modifying a surface of an electrical insulation system and providing said surface with an improved tracking and erosion resistance is provided, the sol-gel composition comprising:

(a) a cyclo-aliphatic epoxy resin compound containing at least two 1,2-epoxy groups per molecule;

(b) a glycidoxypropane-tri(C₁₋₄)alkoxysilane;

(c) a gamma-aminopropyl-tri(C₁₋₄)alkoxysilane;

(d) a mineral filler material; and

(e) a hydrophobic compound selected from a fluorinated or chlorinated hydrocarbon or organopolysiloxane or a mixture thereof;

wherein

the ratio of the epoxy equivalents of component (a) to the epoxy equivalents of component (b) is from 9:1 to 6:4;

the molar ratio of component (c) to the epoxy equivalents of the sum of component (a) and component (b) is from about 0.9 to 1.1;

the mineral filler material is present in a quantity of about 55% by weight to about 85% by weight, based on the total weight of the cured composition;

the hydrophobic compound is present in a quantity of about 1.0% by weight to about 10% by weight, based on the total weight of the cured composition;

wherein the curable sol-gel composition optionally contains an additive.

### DETAILED DESCRIPTION

According to an exemplary aspect, an electrical insulation system made from a synthetic polymer composition, such as an aromatic or a cycloaliphatic epoxy resin composition or a polyurethane composition, can be coated with an exemplary thin coat, so that the insulation system passes the 3.5 kV level of the inclined tracking and erosion test (class 1A3.5 according to standard IEC 60587). Said thin coat can be an electrically non-conductive hydrophobic polymeric material which is obtained by applying an exemplary selected sol-gel composition to the surface, for example, to the outer surface, of the electrical insulation system and curing said sol-gel composition. This can allow the production of low cost coatings for comparatively low-cost electrical insulator compositions and can provide these electrical insulators with a superior tracking and erosion resistance even compared to the commonly used outdoor insulators based on cycloaliphatic epoxy resin compositions. Further, the cured coating composition can have a high hydrophobicity and high adhesion to the basic outer surface of the electrical insulator.

Disclosed is an exemplary curable sol-gel composition useful for modifying the surface of a conventional electrical insulation system and providing said surface with an improved tracking and erosion resistance, wherein said sol-gel composition comprises:

a cyclo-aliphatic epoxy resin compound containing at least two 1,2-epoxy groups per molecule [component (a)],

a glycidoxypropane-tri(C₁₋₄)alkoxysilane [component (b)],

a gamma-aminopropyl-tri(C₁₋₄)alkoxysilane [component (c)],

a mineral filler material [component (d)], and

a hydrophobic compound [component (e)] or a mixture of such hydrophobic compounds being selected from the group comprising fluorinated or chlorinated hydrocarbons or organopolysiloxanes,

wherein, for example, the ratio of the epoxy equivalents of component (a) to the epoxy equivalents of component (b) is from 9:1 to 6:4, the molar ratio of component (c) to the epoxy equivalents of the sum of [component (a)] and [component (b)] is from about 0.9 to 1.1, the mineral filler material [component (d)] is present in a quantity of about 55% by weight to about 85% by weight, calculated to the total weight of the cured composition, the hydrophobic compound [component (e)] is present in a quantity of about 1.0% by weight to about 10% by weight, calculated to the total weight of the cured composition, whereby, for example, the curable sol-gel composition optionally contains further additives.

Also disclosed is an exemplary method of making said curable sol-gel composition. Further disclosed is the exemplary use of said curable sol-gel composition for modifying the surface of an electrical insulation system said insulation system being made from a hardened or cured conventional synthetic polymer composition, to yield an electrical insulation system with improved tracking and erosion resistance.

Further disclosed is an exemplary electrical insulation system wherein the surface of said electrical insulation system, for example, the outer surface of said electrical insulation system, is coated with an exemplary thin coating composition.

Also disclosed is an exemplary method of producing an electrical insulation system being coated with a thin coating composition as defined in the present disclosure, comprising applying an uncured sol-gel composition as defined in the present disclosure to the surface of an electrical insulation system, for example, applying to the outer surface of an electrical insulation system, as a thin coating, and subsequently curing said sol-gel composition.

Electrical insulation systems can be made from a synthetic polymer composition comprising, for example, an aromatic and/or a cycloaliphatic epoxy resin composition or a polyester, for example poly(methyl-methacrylate) or poly(alkylacrylonitrile), or a polyurethane composition. According to an exemplary aspect, the surface of an electrical insulation system may be covered with an exemplary coating.

Component (a) of the sol-gel composition is a cyclo-aliphatic epoxy resin compound containing at least two 1,2-epoxy groups per molecule. Cycloaliphatic epoxy resin compounds useful for the present disclosure comprise, for example, unsubstituted glycidyl groups and/or glycidyl groups substituted with methyl groups. These glycidyl compounds can have an epoxy value (equiv./kg) of, for example, at least three, for example, at least four and, for example, at least about five or higher, for example, about 5.0 to 6.1. For example, an optionally substituted epoxy resins of formula (I) can be used:

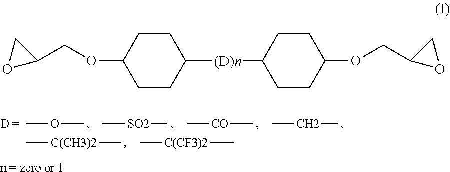

Compounds of formula (I) wherein D is —(CH₂)— or [—C(CH₃)₂—] can be used. Further cycloaliphatic epoxy resins [component (a)] can include, for example, hexahydro-o-phthalic acid-bis-glycidyl ester, hexahydro-m-phthalic acid-bis-glycidyl ester or hexahydro-p-phthalic acid-bis-glycidyl ester.

Exemplary cycloaliphatic epoxy resin compounds can be liquid at room temperature or when heated to a temperature of up to about 65° C. Exemplary cycloaliphatic epoxy resin compounds can include, for example, Araldite® CY 184 (Huntsman Advanced Materials Ltd.), a cycloaliphatic epoxy resin compound (diglycidylester) having an epoxy content of 5.80-6.10 (equiv/kg). For example, cycloaliphatic epoxy resin compounds based on a diglycidyl ester of hexahydrophthalic acid can be used.

Component (b) can be glycidoxypropane-trimethoxysilane (GPTMS).

The ratio of the epoxy equivalents of component (a) to the epoxy equivalents of component (b) can be from 9:1 to 6:4, for example, from 8:1 to 6:4, for example, about 7:3.

Component (c) can be gamma-aminopropyl-triethoxysilane (GAPES). The molar ratio of component (c) to the epoxy equivalents of the sum of [component (a)] and [component (b)] can be from about 0.9 to 1.1, for example, from 0.95 to 1.05, for example, about 1:1.

The mineral filler material can be selected from silicone oxides (silica, quartz), silicates such as sodium/potassium silicates and/or aluminosilicates, for example, layered silicates, aluminium oxide, aluminium trihydrate [ATH], titanium oxide or dolomite [CaMg(CO₃)₂], metal nitrides, such as silicon nitride, boron nitride and aluminium nitride or metal carbides, such as silicon carbide. For example, layered silicates, silica and quartz, the silica and quartz having a minimum SiO₂-content of about 95-97% by weight can be used.

The mineral filler compound or the mixture of such compounds can have an average grain size (at least 50% of the grains) in the range of from about 100 nm to 200 μm, for example, in the range of from 500 nm to 100 μm, for example, in the range of from 5 μm to 100 μm, for example, in the range of from 5 μm to 40 μm, for example, in the range of from 5 μm to 35 μm. The filler material may be surface treated, for example silanized.

The mineral filler material can be present in a quantity of about 55% by weight to about 85% by weight, for example, 65% by weight to 80% by weight, for example, 70% by weight to 80% by weight, calculated to the total weight of the cured composition.

The filler material optionally may be present in a porous form. As a porous filler material, which optionally may be coated, is understood, that the density of said filler material is within the range of 60% to 80%, compared to the real density of the non-porous filler material. Such porous filler materials can have a higher total surface area than the non-porous material. Said surface area can be higher than 0.3 m²/g (BET m²/g), for example, higher than 0.4 m²/g (BET), for example, within the range of 0.4 m²/g (BET) to 100 m²/g (BET), for example, within the range of 0.4 m²/g (BET) to 80 m²/g (BET).

The hydrophobic compound or the mixture of hydrophobic compounds can be selected from the group comprising fluorinated or chlorinated hydrocarbons or cyclic, linear or branched organopolysiloxanes. For example, the hydrophobic compound can be a flowable compound.

Fluorinated or chlorinated hydrocarbons can include compounds containing —CH₂-units, —CHF-units, —CF₂-units, —CF₃-units, —CHCl-units, —C(Cl)₂-units, —C(Cl)₃-units, or mixtures thereof. The fluorinated or chlorinated hydrocarbon can be a flowable compound. The organopolysiloxane may be a cyclic, linear or branched organopolysiloxane and can be a flowable compound. Said hydrophobic compound or said mixture of said compounds may be present in encapsulated form.

The hydrophobic compound can have a viscosity in the range from 50 cSt to 10,000 cSt, for example, in the range from 100 cSt to 10,000 cSt, for example, in the range from 500 cSt to 3000 cSt, measured in accordance with DIN 53 019 at 20° C.

For example, the hydrophobic compound can comprise a compound, or a mixture of compounds, of the general formula (II):

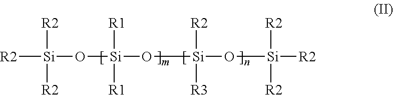

wherein
R1 independently of each other is an unsubstituted or chlorinated or fluorinated alkyl radical having from 1 to 8 carbon atoms, (C₁-C₄-alkyl)aryl, or is aryl;
R2 independently at each other has one of the definitions of R1 or R3, it being possible for two terminal substituents R2 attached to different Si-atoms, being taken together to be an oxygen atom (=cyclic compound);
R3 has one of the definitions of R1, or is hydrogen or a residue —CH₂—[CH—CH₂(O)] or —C₂H₄—[CH—CH₂(O)];

m is on average from zero to 5000;

n is on average from zero to 100;

the sum of [m+n] for non-cyclic compounds being at least 20, and the sequence of the groups —[Si(R1)(R1)O]— and —[Si(R2)(R3)O]— in the molecule being arbitrary.

The formula —[CH—CH₂(O)] has the meaning the epoxy substituent.

For example, an exemplary compound is the compound of the formula (II), wherein R1 independently of each other is an unsubstituted or fluorinated alkyl radical having from 1 to 4 carbon atoms or is phenyl; m is on average from 20 to 5000; n is on average from 2 to 100; the sum of [m+n] for non-cyclic compounds being on average in the range from 20 to 5000, and the sequence of the groups —[Si(R1)(R1)O]— and —[Si(R2)(R3)O]— in the molecule being arbitrary.

For example, an exemplary compound is the compound of the formula (II), wherein R1 independently of each other is 3,3,3-trifluoropropyl, monofluoromethyl, difluoromethyl, or alkyl having 1-4 carbon atoms; m is on average from 50 to 1500; n is on average from 2 to 20; the sum of [m+n] for non-cyclic compounds being on average in the range from 50 to 1500, and the sequence of the groups —[Si(R1)(R1)O]— and —[Si(R2)(R3)O]— in the molecule being arbitrary. For example, an exemplary compound is a compound of the formula (II) wherein each R1 is methyl.

Exemplary cyclic compounds of formula (II) include those comprising 4-12, for example, 4-8, —[Si(R1)(R1)O]-units or —[Si(R2)(R3)O]-units or a mixture of these units.

The hydrophobic compound [component (e)] can be present in a quantity of about 1.0% by weight to about 10% by weight, for example, from 3% by weight to 8% by weight, for example, from 4% by weight to 7% by weight and, for example, from 5% by weight to 6% by weight, calculated to the total weight of the cured composition.

The coating applied with an exemplary sol-gel composition using a sol-gel technique followed by curing can have a thickness within the range of, for example, about 0.5 μm to about 4 mm; for example, within the range of about 1.0 μm to about 3 mm.

The curable sol-gel composition may optionally contain further additives. Such optional additive may be, for example, a curing catalyst; a flexibilizer; a solvent/diluent such as methanol, ethanol or propanol; a fluoroalkylsilane or fluoroalkoxysilane; pigments, antioxidants, light stabilizers and polymeric modifiers.

The curing catalyst, such as 1-methylimidazole, can be added, for example, in an amount of 2% to 4% by weight, calculated to the amount of the sum of component (a) and component (b).

The flexibilizer, such as 2,2-dimethyl-1,3-propanediol, can be added, for example, in an amount of 12% to 14% by weight, calculated to the amount of the sum of component (a) and component (b).

The solvent such as methanol, ethanol or propanol, can be added in order to achieve a sol-gel formulation with a low enough viscosity so that the sol-gel formulation can be easily applied to the surface of the electrical insulator. The solvent can be evaporating on curing the sol-gel formulation. The solvent can be added in an amount of 5% to 10%, for example, about 5.5% to 7.7% by weight, calculated to the total weight of the sol-gel composition.

The antioxidant can be optionally added, for example, in a concentration of up to 1.5% by weight calculated to the total weight of the composition. For example, phenolic or amine antioxidants can be used such as 2,6-tert.-butyl-p-cresol, N,N′-diphenyl-p-phenylene diamine.

Further disclosed is an exemplary method of making said curable sol-gel composition. For making the sol-gel composition, all the components can be well mixed together. For example, the optional catalyst can be added at the end and just before applying the sol-gel composition to the surface of the insulator, i.e. before polymerization between the components (a), (b) and (c) begins.

The application of the sol-gel composition to the substrate, for example, can be made in two steps. Initially component (a), component (b), component (c), and component (e) can be mixed in the presence of a solvent, followed by the addition of component (d). At this point, the dominant reaction can be the fast hydrolysis of the alkoxysilane groups which occurs assisted by the presence of atmospheric water vapor (open flask conditions).

Once hydrolyzed, in a subsequent step, this mixture can be coated onto the substrate, i.e. the surface of the electrical insulator, which can be an epoxy substrate, where upon the mixture condenses and cross-links.

The condensation/curing reaction can be slower than the hydrolysis and at these conditions can be completed within about one to five hours of curing. Finally, during the curing step, besides the condensation of the hydrolyzed alkoxysilanes, the epoxy ring opening polymerization can take place, for example, in the presence of a curing catalyst. The final product can comprise the cross-linked components (b) and (c) via ≡Si—O—Si≡ bonds and cross-linked components (a), (b), (c) and (d) via the epoxy ring opening polymerization reaction. The total curing of the sol-gel composition after being applied to the surface of an insulator can be conducted over a wide range of temperature and time and, for example, can be conducted at about 110° C. for about eight hours.

The method of producing an electrical insulation system being coated with the coating composition, can comprise (i) hydrolyzing the alkoxysilane contained in the sol-gel composition and (ii) applying the hydrolysed uncured sol-gel composition to the surface of an electrical insulation system as a thin coating, for example, applying to the outer surface of an electrical insulation system, and subsequently curing said sol-gel composition.

Exemplary uses of the surface modified electrical insulation system are in power transmission and distribution applications, such as electrical insulations, for example, in the field of impregnating electrical coils and in the production of electrical components such as transformers, embedded poles, bushings, high-voltage insulators for indoor and outdoor use, for example, for outdoor insulators associated with high-voltage lines, as long-rod, composite and cap-type insulators, sensors, converters and cable end seals as well as for base insulators in the medium-voltage sector, in the production of insulators associated with outdoor power switches, measuring transducers, lead-throughs, and over-voltage protectors, in switchgear construction.

### EXAMPLES

### Example 1

Exemplary formulations, i.e., compositions, were prepared by mixing all the components besides the filler as given in Table 1 in a vessel fitted with a magnetic stirrer for two hours at room temperature. After the addition of the filler, the formulation was further mixed with a Eurostar IKA Labortechnik mixer at room temperature for thirty minutes.

TABLE 1

| Components: | | |
|---|---|---|
| Cyclo-aliphatic epoxy resin (a) | 100 | parts |
| Glycidoxypropane-trimethoxy silane (b) | 60-70 | phr |
| Gamma-aminopropyl-triethoxyy silane (c) | 150-160 | phr |
| Silanized ultra-fine, Filler (d) | 392-1710 | phr |
| Silicone oil (e) | 10.8-181 | phr |
| Optional additives: | | |
| Fluoroalkylsilane | 0.15-25 | phr |
| 1-methylimidazol | 2-4 | phr |
| 2,2-dimethyl-1,3-propandiol | 0.12-14 | phr |

phr = parts per hundred
(a) Cyclo-aliphatic epoxy resin, based on diglycidyl ester of hexahydro-phthalic acid (Huntsman CY184)
(b) GPTMS, Z-6040, Dow Corning Corp.
(c) GAPES, A110, Momentive Corp.
(d) Filler: W12EST, Quarzwerke AG, 55-77% by weight, calculated to the total weight of components (a), (b), (c) and (e)
(e) silicone oil: AK50 of Wacker Chemie AG, 1-10% by weight, calculated to the weight of the total composition
Fluoroalkylsilane: Dynasylan F8261, Evonik Degussa
1-methylimidazol: DY 070, Huntsman Corp.
2,2-dimethyl-1,3-prpandiol: NPG, Fluka

### Example 2

Components (a), (b), (c), and (e) are mixed in the presence of the solvent, followed by the addition of component (d) as described in Example 1. Hydrolysis of the alkoxysilanes is achieved by the presence of atmospheric water vapor (open flask conditions) whereby the condensation reaction is completed in a later stage during curing.

These formulations are applied via spin coating to cured plates of cured indoor epoxy resin compositions of dimensions 12 cm×5 cm×0.6 cm. The samples are cured for eight hours at 110° C. and tested with the inclined tracking and erosion testing at 3.5 kV.

The substrate formulation was degassed for 10-15 minutes at 4 mbar and cured at 90° C. for two hours followed by curing at 110° C. for 24 hours.

The basic formulation used as a substrate is described in the following Table 2:

TABLE 2

| Component | Function | Name | phr |
|---|---|---|---|
| DER 331 | Epoxy Resin | Diglycidyl ether of | 100 |
| (Dow) | | Bisphenol A | |
| MTHPA NT | Hardener | Methyl-tetrahydro- | 85 |
| (Lonza) | | phthalic anhydride | |
| DY 062 | Catalyst | Benzyl-N,N- | 0.9 |
| (Huntsman) | | dimethylamine | |
| W12 (65%) | Filler | Silica | 345 |
| (Quarzwerke) | | | |

An example of two different sol-gel formulations that led to samples that passed the 3.5 kV level of the inclined tracking and erosion test is presented in the following Table 3. When using a higher amount of silicone oil the fluoroalkylsilane and the flexibilizer are not required and the viscosity remains sufficiently low leading to easy processing of the formulation without the need of additional amounts of solvent.

According to the inclined tracking and erosion test (class 1A3.5, IEC 60587) a sample is considered to have successfully passed the test when the leakage current does not overcome 60 mA for more than 2 seconds in a period of 6 hours. The samples of Formulations 1 and 2 (of Table 3) fulfilled the above criterion. In addition, for various samples of Formulation 1 the measurement was repeated until the failure of the sample. The average time of failure, in the case of Formulation 1, was found to 13.2±3.6 hours, more than 100% higher than the 6 hour period necessary or recommended for the tracking and erosion test to be considered successful.

TABLE 3

| | | Formulation 1 | | Formulation 2 | |
|---|---|---|---|---|---|
| Component | Function | % | phr | % | phr |
| CY184 | Epoxy resin | | 100 | | 100 |
| GPTMS | Epoxy-silane | | 65.4 | | 65.4 |
| GAPES | Amino-silane | | 153.8 | | 153.8 |
| DY070 | Catalyst | | 2.15 | | 2.15 |
| F8261 | Fluoro-silane | | 15.4 | | 0 |
| NPG | Flexibilizer | | 12.7 | | 0 |
| AK50 | Silicone oil | 4.9% | 92.2 | 6.6% | 126.4 |
| W12EST | Filler | 76.5% | 1440 | 76.5% | 1459 |
| Ethanol | Solvent | 7.3% | 148.4 | 7.3% | 150.3 |

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A curable sol-gel composition suitable for modifying a surface of an electrical insulation system and providing said surface with an improved tracking and erosion resistance, the sol-gel composition comprising:
(a) a cyclo-aliphatic epoxy resin compound containing at least two 1,2-epoxy groups per molecule;
(b) a glycidoxypropane-tri(C₁₋₄)alkoxysilane;
(c) a gamma-aminopropyl-tri(C₁₋₄)alkoxysilane;
(d) a mineral filler material; and
(e) a hydrophobic compound selected from a fluorinated or chlorinated hydrocarbon or organopolysiloxane or a mixture thereof;
wherein
the ratio of the epoxy equivalents of component (a) to the epoxy equivalents of component (b) is from 9:1 to 6:4;
the molar ratio of component (c) to the epoxy equivalents of the sum of component (a) and component (b) is from about 0.9 to 1.1;
the mineral filler material is present in a quantity of about 55% by weight to about 85% by weight, based on the total weight of the cured composition;
the hydrophobic compound is present in a quantity of about 1.0% by weight to about 10% by weight, based on the total weight of the cured composition;
wherein the curable sol-gel composition optionally contains an additive.

2. The composition according to claim 1, wherein the cycloaliphatic epoxy resin compound comprises unsubstituted glycidyl groups and/or glycidyl groups substituted with methyl groups having an epoxy value (equiv./kg) of at least three.

3. The composition according to claim 2, wherein the cycloaliphatic epoxy resin is a compound of formula (I):

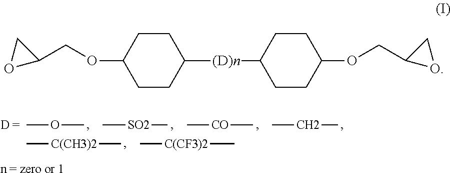

4. The composition according to claim 2, wherein the cycloaliphatic epoxy resin is a hexahydro-o-phthalic acid-bis-glycidyl ester, hexahydro-m-phthalic acid-bis-glycidyl ester or hexahydro-p-phthalic acid-bis-glycidyl ester.

5. The composition according to claim 1, wherein component (b) is glycidoxypropane-trimethoxysilane (GPTMS).

6. The composition according to claim 1, wherein the ratio of the epoxy equivalents of component (a) to the epoxy equivalents of component (b) is from 8:1 to 6:4.

7. The composition according to claim 1, wherein component (c) is gamma-aminopropyl-triethoxysilane (GAPES).

8. The composition according to claim 1, wherein the molar ratio of component (c) to the epoxy equivalents of the sum of component (a) and component (b) is from about from 0.95 to 1.05.

9. The composition according to claim 1, wherein the mineral filler material comprises a silicone oxide, a silicate, a layered silicate, aluminum oxide, aluminum trihydrate [ATH], titanium oxide, dolomite [CaMg(CO₃)₂], a metal nitride, a metal carbide or a combination thereof.

10. The composition according to claim 1, wherein the mineral filler material is present in a quantity of 65% by weight to 80% by weight, based on the total weight of the cured composition.

11. The composition according to claim 1, wherein the density of said filler material is within the range of 60% to 80%, compared to the density of a non-porous material formed from the same material as the filler material.

12. The composition according to claim 1, wherein the hydrophobic compound comprises a compound of the general formula (II): 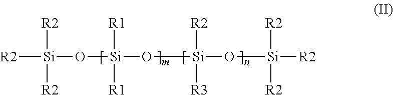
wherein
R1 independently of each other is an unsubstituted or chlorinated or fluorinated alkyl radical having from 1 to 8 carbon atoms, (C1-C4-alkyl)aryl, or is aryl;
R2 independently of each other has one of the definitions of R1 or R3, it being possible for two terminal substituents R2 attached to different Si-atoms, being taken together to be an oxygen atom;
R3 has one of the definitions of R1, or is hydrogen or a residue —CH₂—[CH—CH₂(O)] or —C₂H₄—[CH—CH₂(O)];
m is on average from zero to 5000;
n is on average from zero to 100;
the sum of [m+n] for non-cyclic compounds being at least 20, and the sequence of the groups —[Si(R1)(R1)O]— and —[Si(R2)(R3)O]— in the molecule being arbitrary.

13. The composition according to claim 12, wherein the compound of the formula (II), is a compound wherein R1 independently of each other is an unsubstituted or fluorinated alkyl radical having from 1 to 4 carbon atoms or is phenyl; m is on average from 20 to 5000; n is on average from 2 to 100; the sum of [m+n] for non-cyclic compounds being on average in the range from 20 to 5000, and the sequence of the groups —[Si(R1)(R1)O]— and —[Si(R2)(R3)O]— in the molecule being arbitrary.

14. The composition according to claim 12, wherein the compound of the formula (II), is a compound wherein R1 independently of each other is 3,3,3-trifluoropropyl, monofluoromethyl, difluoromethyl, or alkyl having 1-4 carbon atoms, m is on average from 50 to 1500; n is on average from 2 to 20; the sum of [m+n] for non-cyclic compounds being on average in the range from 50 to 1500, and the sequence of the groups —[Si(R1)(R1)O]— and —[Si(R2)(R3)O]— in the molecule being arbitrary.

15. The composition according to claim 12, wherein the compound of formula (II) comprises 4-12-[Si(R1)(R1)O]-units, or 4-12-[Si(R2)(R3)O]-units, or 4-12 of a mixture of —[Si(R1)(R1)O]-units and —[Si(R2)(R3)O]-units.

16. The composition according to claim 1, wherein the hydrophobic compound is present in a quantity of from 3% by weight to 8% by weight, based on the total weight of the cured composition.

17. The composition according to claim 1, wherein said composition further comprises a curing catalyst; a flexibilizer; a solvent/diluent such as methanol, ethanol or propanol; a fluoroalkylsilane or fluoroalkoxysilane; a pigment, an antioxidant, a light stabilizer; a polymeric modifier; or a combination thereof.

18. The composition according to claim 17, wherein said curing catalyst is 1-methylimidazole, and is present in an amount of 2% to 4% by weight, based on the amount of the sum of component (a) and component (b).

19. The composition according to claim 17, wherein the flexibilizer is 2,2-dimethyl-1,3-propanediol and is added in an amount of 12% to 14% by weight, based on the amount of the sum of component (a) and component (b).

20. The composition according to claim 17, wherein the solvent is methanol, ethanol and/or propanol, and is present in an amount of 5% to 10%, based on the total weight of the sol-gel composition.

21. A method of making the curable sol-gel composition according to claim 1, the method comprising mixing components (a) to (e), wherein an optional catalyst is added to the mixture prior to applying the mixture to a substrate.

22. The method according to claim 21, wherein initially component (a), component (b), component (c), and component (e) are mixed in the presence of a solvent, followed by the addition of component (d) and the hydrolysis of the alkoxysilane groups occurring in the presence of atmospheric water vapor, wherein the method further comprises coating the resulting mixture onto the substrate.

23. A method of producing an electrical insulation system coated with a coating composition, the method comprising:
(i) providing the sol-gel composition according to claim 1;
(ii) applying the sol-gel composition to the surface of an electrical insulation system as a thin coating; and
(iii) curing the applied sol-gel composition.

24. The method according to claim 23, wherein said coating applied with the sol-gel composition has a thickness within the range of about 0.5 μm to about 4 mm.

25. The method according to claim 23, wherein the coated and cured electrical insulation system has an improved tracking and erosion resistance in comparison with the uncoated electric insulation system, wherein the insulation system is made from a hardened or cured synthetic polymer composition.

26. A coated electrical insulation system, comprising:
an electrical insulation system; and
a coating of the composition according to claim 1, wherein the coating is on a surface of the electrical insulation system.

27. The composition according to claim 1, wherein the cycloaliphatic epoxy resin compound comprises unsubstituted glycidyl groups and/or glycidyl groups substituted with methyl groups having an epoxy value (equiv./kg) of at least four.

28. The composition according to claim 1, wherein the cycloaliphatic epoxy resin compound comprises unsubstituted glycidyl groups and/or glycidyl groups substituted with methyl groups having an epoxy value (equiv./kg) of about 5.0 to 6.1.

29. The composition according to claim 3, wherein in the compound of formula (I), D is —(CH₂)— or [—C(CH₃)₂—].

30. The composition according to claim 1, wherein the mineral filler material comprises a silica, quartz, a sodium/potassium silicate, an aluminosilicate, silicon nitride, boron nitride, aluminium nitride, silicon carbide or a combination thereof.

31. The composition according to claim 1, wherein the mineral filler material comprises a layered silicate, silica, quartz or a combination thereof.

32. The composition according to claim 1, wherein the mineral filler material is present in a quantity of 70% by weight to 80% by weight, based on the total weight of the cured composition.

33. The composition according to claim 14, wherein the compound of the formula (II), is a compound wherein R1 independently of each other is 3,3,3-trifluoropropyl, monofluoromethyl, difluoromethyl, or methyl.

34. The composition according to claim 12, wherein the compound of formula (II) comprises 4-8-[Si(R1)(R1)O]-units, or 4-8-[Si(R2)(R3)O]-units, or 4-8 of a mixture of —[Si(R1)(R1)O]-units and —[Si(R2)(R3)O]-units.

35. The composition according to claim 1, wherein the hydrophobic compound is present in a quantity of from 4% by weight to 7% by weight, based on the total weight of the cured composition.

36. The composition according to claim 1, wherein the hydrophobic compound is present in a quantity of from 5% by weight to 6% by weight, based on the total weight of the cured composition.

37. The composition according to claim 17, wherein the solvent/diluent includes methanol, ethanol and/or propanol.

38. The composition according to claim 17, wherein the solvent is methanol, ethanol and/or propanol, and is present in an amount of 5.5% to 7.7% by weight, based on the total weight of the sol-gel composition.

39. The method according to claim 23, wherein the sol-gel composition is applied to the outer surface of the electrical insulation system as a thin coating.

40. The method according to claim 23, wherein said coating applied with the sol-gel composition has a thickness within the range of about 1.0 μm to about 3 mm.

41. The coated electrical insulation system of claim 26, wherein the coating is on an outer surface of the electrical insulation system.
